(19) United States
(12) Patent Application Publication
(10) Pub. No.: US 2015/0067990 A1
(43) Pub. Date: Mar. 12, 2015

(54) FLEXIBLE TAPE HOLDING DEVICE

(71) Applicant: George Arena, Billerica, MA (US)

(72) Inventor: George Arena, Billerica, MA (US)

(21) Appl. No.: 14/022,459

(22) Filed: Sep. 10, 2013

(51) Int. Cl. F16B 2/00

(52) U.S. Cl. CPC F16B 2/00
USPC 24/301

(57) ABSTRACT

A flexible tape holding device that holds multiple rolls of adhesive tape, where said device comprises a flexible elongated strap with a locking head on one end and a threaded end on the second end. Either end is passed through the center aperture of the rolls of tape to securely group multiple rolls of tape together.

### BACKGROUND OF THE INVENTION

1. Field of the Invention

The present invention relates to a flexible tape holding device that holds together multiple rolls of adhesive tape.

2. Description of Related Art

It is a common protocol for both professional and amateur hockey players to apply hockey tape to their sporting gear before a game. Hockey players use different types of hockey tape in order to protect their hockey stick blades and to affix padding equipment. Furthermore, hockey tape also prevents moisture from building up on the hockey stick blade and thus adds grip to the otherwise wet and slippery puck. Typically, a cloth-based self-adhesive is used to wrap the hockey stick blade. However, hockey players also employ a different kind of textured tape made of a thin layer of rubber to wrap their hockey stick blades. Further, yet another different kind of medical-type tape is used to affix their padding equipment to their person.

Hockey players regularly carry rolls of the aforementioned types of hockey tapes in their sport bags; due to the combative nature of the sport, said hockey stick blades must be regularly rewrapped and padding equipment must be constantly reapplied. However, carrying rolls of hockey tape in a sports bag is problematic for hockey players because, as one of the smallest objects in said bag, it is not readily accessible and may be easily lost or misplaced. Hockey players must go through an irritating ritual of ransacking through their sports bag to find the roll of hockey tape they desire.

It would be desirable in the art to provide a holding device to store, organize, and group together different types of rolls of hockey tape. It would also be beneficial in the art to provide a flexible holding device for hockey tape that can be readily accommodated in a sports bag.

### SUMMARY OF THE INVENTION

The present invention relates to a device that holds multiple of rolls of hockey tape. The present invention specifically relates to a flexible strap that forms into a circular band to hold multiple rolls of tape. The flexible strap is passed through the aperture in the center of the rolls of tape and comprises a locking device that locks the two opposite ends of the strap to keep the rolls of tape from escaping the strap. The flexible strap is made of a rubber material and may be customized to include various colors, sports team logos, and shapes.

### BRIEF DESCRIPTION OF THE DRAWINGS

The advantages and features of the present invention will become better understood with reference to the following detailed description and claims taken in conjunction with the accompanying drawing and in which:

FIG. 1 depicts a perspective view of a tape holding device in accordance with an exemplary embodiment of the present invention.

### DETAILED DESCRIPTION OF THE DRAWINGS

The present invention relates to a device that holds multiple rolls of hockey tape. More specifically, the present invention relates to a flexible strap that forms into a circular band to hold multiple rolls of tape together. The flexible strap is passed through the center aperture of the rolls of tape. Further, the flexible strap comprises a locking head that locks the ends of the strap. The locking head has a strap receiving passage with means to slide and lock said threaded end. The flexible strap is made of a rubber material and may be customizable.

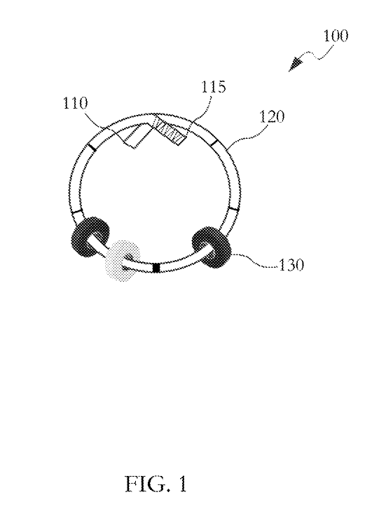

Turning now descriptively to the drawing, referring to FIG. 1, a perspective view of a tape holding device 100 in accordance with an exemplary embodiment of the present invention.

The tape holding device 100 comprises a flexible elongated strap 120, a locking head 110, a threaded end 115, and rolls of adhesive tape 130. The tape holding device 100 comprises a flexible elongated strap 120 that is made of a rubber or any other suitable flexible material. The locking head 110 is disposed at one end of the flexible elongated strap 120 and the threaded end 115 is disposed on the opposite end of the flexible elongated strap 120.

Either end of the flexible elongated strap 120 is passed through the center aperture of rolls of adhesive tape 130. The locking head 110 comprises a strap receiving passage with means to slide and lock the threaded end 115. Locking the threaded end 115 of the flexible elongated strap 120 to the locking head 110 forms a circular band that holds multiple rolls of adhesive tape 130. The flexible elongated strap 120 measures between 12 and 14 inches in length and ¾ inches in width. Further, the center aperture in the adhesive tape 130 may be of varying diameters because the flexible elongated strap 120 accommodates various proportions of rolls of adhesive tape 130. The flexible elongated strap 120 may be customized to display different colors, shapes, and logos.

The foregoing descriptions of specific embodiments of the present invention have been presented for purposes of illustration and description. They are not intended to be exhaustive or to limit the invention to the precise forms disclosed, and obviously many modifications and variation are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A tape holding device comprising:
a. a flexible elongated strap, where said flexible elongated strap has a first end and a second end, and where said flexible elongated strap holds multiple of rolls of tape;
b. a threaded end, where said threaded end is disposed on said second end of said flexible elongated strap; and
c. a locking head, where said locking head is disposed on said first end of said flexible elongated strap, and where said locking head has a strap receiving passage with means to slide and lock said threaded end.

2. The tape holding device according to claim 1, where said flexible elongated strap is made of a rubber material.

3. The tape holding device according to claim 1, where said elongated strap measures 14 inches in length.

4. The tape holding device according to claim 1, where said elongated strap may be customized to display a variety of colors, shapes, and logos.

5. The tape holding device according to claim 1, where said locking head is in the shape of a snake.

6. The tape holding device according to claim 1, where said multiple rolls of tape are multiple rolls of hockey tape.
